(19) United States
(12) Patent Application Publication
(10) Pub. No.: US 2014/0052346 A1
(43) Pub. Date: Feb. 20, 2014

(54) SOFT START WINDOW REGULATOR

(71) Applicants: Paul L. Heirtzler, Northville, MI (US); Donald P. Lacovoni, Plymouth, MI (US)

(72) Inventors: Paul L. Heirtzler, Northville, MI (US); Donald P. Lacovoni, Plymouth, MI (US)

(73) Assignee: FORD GLOBAL TECHNOLOGIES, LLC, Dearborn, MI (US)

(21) Appl. No.: 13/587,988

(22) Filed: Aug. 17, 2012

(51) Int. Cl. B60J 1/17; E05F 15/20

(52) U.S. Cl. 701/49

(57) ABSTRACT

A system and method is provided for regulating a window in a vehicle. The system includes a vehicular window frame that supports the window, a regulator motor, and a drive arrangement that is connected to the window frame, the regulator motor, and the window, to operate the window. A window activation switch is connected to a vehicular power source and the regulator motor for window operations, and is connected to a control unit as well. The control unit includes a first mode of operation which causes the regulator motor and drive arrangement to move the window at a first speed, and a second mode of operation enabling the window to travel further at a different second speed.

### BACKGROUND

This invention relates generally to window related operations in vehicles.

Current vehicular provisions for window operation control include a switch, which generally, when depressed and pulled, enables the window to be lowered and raised, respectively, in relation to a vehicular window frame. When an operator activates the switch, there is a voltage applied close to 14 volts, which is typically in full measure, to a window motor, commonly referred to as a regulator motor, activating a drive arrangement and consequently moving the window up and/or down. Such application, however, does not enable the operator to obtain a desired window position easily, as the movement of the window remains proportional to the applied voltage, which when applied in full measure causes the window movement to be considerably quick. It is difficult for a window operator to obtain a very window small opening to vent the vehicle while driving, or when desired otherwise. Often, several up and down movements of the window are needed, before an optimum location has been found.

More particularly, mechanisms within the commonly employed switches are such that they cause the switch's minimum activation time, when operated by a user, to produce a minimum amount of window travel, which on many occasions is greater or lesser than what is desired. Accordingly, a user is left unsatisfied when the minimum window travel runs less or beyond a desired window position, or if a window movement occurs too slow or too fast. It is difficult for the operator to accurately react, control, and stop the window. As a result, the operator is not equipped to obtain a desired window position in a timely and convenient fashion. In current practices, the operator may need to repeatedly apply the switch to achieve a desired window placement.

Thus, there remains a need to attain an improved window movement and operational control that can position windows in an easy and efficient manner.

### SUMMARY

One embodiment of the present disclosure describes a window regulation system in a vehicle. The system includes a window, a vehicular window frame, which supports the window, a regulator motor, and a drive arrangement that is connected to the window frame, the regulator motor, and to the window, for raising and lowering the window in relation to the vehicular window frame. A window activation switch is connected to a vehicular power source and to the regulator motor for window operation, and in turn, a control unit is connected to the window activation switch as well. More specifically, the control unit includes a first mode of operation which causes the regulator motor and drive arrangement to move the window at a first speed, and a second mode of operation enabling the window to travel further at a different second speed.

Another embodiment of the present disclosure describes a method to regulate a window in a vehicle. The method includes activating a window activation switch, connected to a vehicular power source and to a regulator motor, thereby enabling window operations, the switch's activation forming an input signal. The method further includes transferring the input signal to a control unit and processing the input signal via the control unit to establish an output, forming a processed signal. Thereafter, transferring the processed signal to the regulator motor eventually, enables regulating the window's operation via the processed signal. Here, the window's operation is enabled through a drive arrangement and the drive arrangement in turn is configured to operate the window in relation to a vehicular window frame. More specifically, the control unit, providing the processed signal, includes a first mode of operation, which causes the regulator motor and a drive arrangement to move the window at a first speed, and a second mode of operation enabling the window to travel further at a different second speed.

Certain embodiments of the present disclosure describe a vehicular window control system. The system includes a window configured be operated through a drive arrangement, where the drive arrangement is operated via a regulator motor, enabling raising and lowering operations of the window in relation to a vehicular window frame. A window activation switch is configured to initiate a flow of power from a vehicular power source to the regulator motor for window operation, the flow of power forming an input signal. Moreover, the window activation switch is connected to a control unit, which is configured to receive the input signal. More particularly, the control unit includes a first mode of operation and a second mode of operation, where the first mode of operation and the second mode of operation control at least one of an incoming voltage value and an incoming current value.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic illustrating an exemplary window regulation system in a vehicle according to the present disclosure.

FIG. 2 is a schematic depicting the different configurations of a window activation switch according to the aspects of the present disclosure.

FIG. 3 is a flowchart depicting an exemplary methodology of the window regulation system of FIG. 1.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes systems and methods for providing a soft start feature for a window operation in a vehicle, enabling the window to be positioned accurately in a short duration. To this end, a control unit is connected to a window activation switch, and in turn includes a first and a second mode of operation, enabling the activation switch to control movement of the window in two modes. The first mode allows the window to be operated at a first speed or a speed profile, and the second mode of operation enables the window to travel further at a different second speed.

### Exemplary Embodiments

In conventional practices, obtaining small window vents in vehicles via in-vehicle window controls is noted to be a rather tedious task for many users. This is observed generally on occasions when the vehicle is in motion, and an occupant desires to open a window to enjoy the outside weather, or to vent the cabin, but also wants to limit the window opening to a small amount, in order to avoid cabin discomfort. For example, it may be desirable to vent the cabin of an odor, but rainy weather outside may cause water to seep inside the cabin through large window vents, causing cabin discomfort. Obtaining small window vents therefore, is desirable. An instant transfer of power however, provided by a user through a power window switch, generally urges the window to travel at an equivalent rate, resulting in hard window starts and quick movements, thereby limiting the user's ability to position the window accurately and timely. This causes window openings to be larger than desired, making accurate window control to be a rather tedious task. The general scheme of the present disclosure includes a control unit, connected to a power window switch, referred to as a window activation switch, to include two modes of operation, where the first mode enables the window to travel at a first speed, while the second mode allows the window to travel at a different second speed. More particularly, the first speed allows a user to position the window accurately as desired. A soft start window regulation system is therefore proposed in this disclosure.

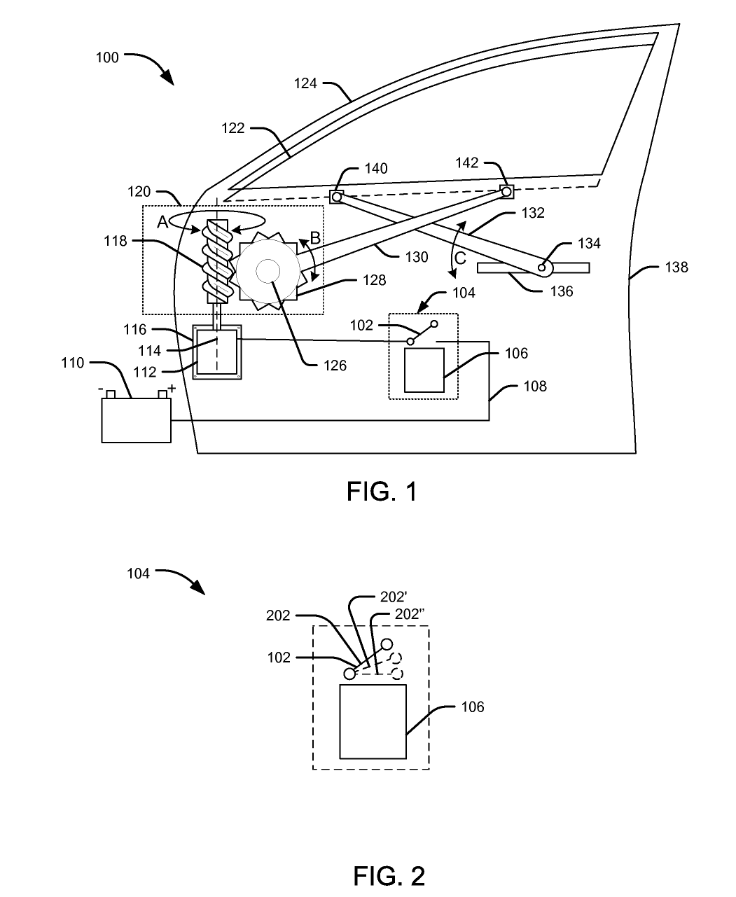

Accordingly, FIG. 1 depicts an exemplary soft start window regulation system 100 installed in a vehicle door 138. The system 100 includes a vehicular window 122 supported by a vehicular window frame 124, where the window frame 124 forms a part of the vehicle door 138. A drive arrangement 120, is connected to the window frame 124 by being mounted within the inner panels of the vehicle door 138, and includes a worm 118 and a worm wheel 128 assembly, forming a worm drive arrangement, configured to raise and lower the window 122 in relation to the window frame 124. Alongside the drive arrangement 120, a regulator motor 112 is coupled to the worm 118, enabling the worm 118 to be rotatably driven according to the arrow A about an axis 114. The drive arrangement 120 is therefore connected to the regulator motor 112, as well. Mated to the worm 118, the worm wheel 128, which is rotatably mounted at a pivot point 126, is configured to be rotatably driven by the worm 118 in a direction shown through the arrow B.

The system 100 further includes a window activation switch 102 to regulate window movements by controlling the flow of power. The switch 102 is connected to the regulator motor 112 on one side, and a power source, referred to as a battery 110, on the other. In preferred embodiments, the battery 110 is a conventional in-vehicular DC power source. The switch 102 is configured to be connected to a control unit 106, as well, with the assembly of the switch 102 and the control unit 106 forming an integrated switching unit 104, as shown. Connection cabling 108 runs around all through the system 100, establishing power flow from the battery 110 all the way to the regulator motor 112.

Further, one end of a first arm 130 is fixedly connected to the worm wheel 128, while its other end is pivotally and slidably connected to a bottom portion of the window 122 at a first fixture 140, as shown. Similarly, one end of a second arm 132 is pivotally and slidably connected to a bottom portion of the window 122 at a second fixture 142. The other end of the second arm 132 is pivotally connected to a member 136 at a pivot point 134, and the member 136 is fixedly mounted to the vehicle door 138. The drive arrangement 120, through the first arm 130 and the second arm 132, is thus connected to the window 122 as well. Raising and lowering the window 122 through the drive arrangement 120 is understood through a rotation of the first arm 130, driven by the worm wheel 128, which in turn is configured to rotate according to the rotation depicted through the arrow B, as noted earlier. Likewise, the second arm 132 guides the window 122, during the raising and lowering operations, by pivoting in a direction depicted by the arrow C. The drive arrangement 120 having a worm wheel arrangement is understood to limit the transfer of movement from the worm 118 towards the worm wheel 128. The reverse is not possible. More explicitly, the disclosed arrangement restricts the power windows to be forced open or forced closed, as the worm and the worm wheel arrangement, having an axially transversal angle of contact, forms a self-locking configuration with each other, enabling the worm 118 to rotate the worm wheel 128, but restricts the worm wheel 128 from spinning the worm 118. Other details and configurations of such window movements are well known to the skilled in the art, and thus will not be discussed further. Moreover, the assemblage and configurations of the window movement, depicted in the present disclosure, need not be seen therefore, as limiting in any way.

The regulator motor 112 is a regular window regulation motor, well known in the art, and is installed within the inner panels of the door 138, with the motor's mounting on the door panels being enabled through a flanged section 116. The mounting may include bolted or welded fastenings, or the like. Similar to conventionally applied motors, the regulator motor 112 is configured to include electrical input and output ports, allowing motor operations through a transfer of electrical energy. Moreover, the rotor shaft of the regulator motor 112 is coupled to the worm 118, enabling the transfer of torque and energy to the worm 118. More particularly, the regulator motor 112 is configured to function and rotate upon an electrical initiation received from the window activation switch 102.

In conventional applications, a window regulation system may include all the above mentioned components, with the exception of the control unit 106. The control unit 106, according to the aspects of the present disclosure, is configured to modulate the value of the current or voltage, applied across the system 100, from the battery 110, all the way to the regulator motor 112. This may be performed through techniques such as Pulse Width Modulation (PWM), or through other methods well known in the art. With the present disclosure, aiming to propose a soft start feature for window regulation, the control unit 106 incorporated is thereby equipped with provisions to modulate the flow of energy to control the window movement more closely and effectively. The provisions of the control unit 106 are discussed further below.

The control unit 106, disposed within the switching unit 104, forms one part of the hardware of the system 100, as depicted. The control unit 106 is a microprocessor based device that includes a CPU, enabled to process the incoming information or electrical signals from a known source. Further, the control unit 106 may be incorporated with volatile memory units, such as a RAM and/or ROM, which function along with associated input and output buses. The control unit 106 may also be optionally configured as an application specific integrated circuit, or may be formed through other logic devices that are well known to those skilled in the art. In addition, the control unit 106 may either be formed as a portion of an externally applied electronic control unit, or may be configured as a stand-alone entity. More particularly, the control unit 106 is configured to include a timer (not shown) to extract time related information for which the switch 102 has been applied or depressed by a user, and a sensor (not shown) to sense a depressed or detent position of the switch 102 during an application. Accordingly, the sensor may be a position sensor. All electrical signals and/or information received from the sensor and/or the timer are configured to be converted and processed through the CPU, and is thereafter configured to be sent further to be processed via algorithms installed and stored in the control unit's memory, eventually forming a processed output.

Forming a part of the control unit 106, the CPU may include multiple microprocessors, multiple memory modules, etc., and these may be referred to as subsystems of the CPU. One of the typical components, generally forming a part of the CPU, is the arithmetic logic unit (ALU) (not shown), which is configured to perform arithmetic and logical operations. It is well understood that the CPU is primarily configured to convert incoming signals received from the sensor and/or timer into a compatible format, further enabling the processing of the received signals through algorithms (discussed below) which is installed within the control unit's memory.

The memory disposed within the control unit 106 can include volatile and non-volatile storage regions that store information related to the overall functioning of the system 100. More particularly, the memory may record information related to the sensed depression detent of the switch 102, along with storing the time for which the window activation switch 102 is depressed. Further, the memory may also be configured to include predetermined functional information, such as predefined schedules, including schedules based on time of window travel and/or distance of window travel, the first speed and the different second speed, one or more algorithms to process the incoming signals, calculation methodologies, voltage and current related values alongside the related window speed values that can be fed in by the user, specifications of the components of the system 100, installed algorithms, etc.

The algorithm disclosed can be a coded language, and is configured to be installed within and stored within the control unit's memory. The algorithm is enabled to process the converted and compatible signals via calculations, with all such compatible and converted signals being received from the microprocessors disposed within the control unit 106. In particular, the algorithm is configured to calculate the amount of voltage or current required to vary the window speed. The details of power transmission, reception, conversion and utilization are discussed later.

In other embodiments (not shown), the regulator motor 112 can be a two speed or two step motor, and the position of the switch 102 can be sensed and then used to determine which of the two speeds needs to be selected.

More particularly, the control unit 106 is configured to include a first mode of operation that causes the regulator motor 112 and the drive arrangement 120 to move the window 122 at a first speed, and a second mode of operation enabling the window 122 to travel further at a different second speed. The first mode of operation and the second mode of operation are configured to control at least one of an incoming voltage value and/or an incoming current value. These modes are activated based on the processed output. More specifically, the first mode is configured to control at least one of an incoming voltage value and/or an incoming current value from the battery 110, thereby controlling the speed of window operation. Accordingly, the first speed is a controlled speed obtained by modulating an incoming voltage/current value, whereas, the different second speed is the speed obtained through the unmodulated value of the incoming voltage/current attained through the battery 110. Alternatively, the control unit 106, in general, may include a multiple modes with differing speed values as well. Accordingly, the modes and a corresponding control of their related voltage/current values along with the related speed values are not limited in any way. The activation and working of these modes is discussed later in the application.

Connected to the regulator motor 112 and the battery 110 on either ends, the window activation switch 102 is configured to enable switching of power from the battery 110 to the system 100. More specifically, the switch 102 is configured to vary the flow of power from the battery 110 via the control unit 106, unlike conventional switching units that do not include control units. FIG. 2 accordingly depicts the switch's configuration in further detail. The switch 102 therefore, as part of the switching unit 104, includes twin switching detents that enable the switch 102 to be depressed in a first depressed state 202′ and in a second depressed state 202″. More particularly, the first depressed state 202′ is when the window activation switch 102 is depressed halfway in relation to a full switch depression, while the second depressed state 202″ is when the window activation switch 102 is fully depressed. During no power flow conditions, the switch 102 remains in an open state 202. Even through the figure depicts the switch 102 to have twin depression states 202′ and 202″ in the downward direction, which may generally be required for opening the window 122, configurations within the aspects of the present disclosure may include the switch 102 to include similar provisions in the upward direction as well to close the window 122. Embodiments not shown can have the switch 102 with more than two depression states as well, adding to the overall proposed configuration disclosed herein.

It is understood that the two modes of operation of the control unit 106 is configured to correspond to the twin switching detents or the depression states 202′ and 202″ of the window activation switch 102, and is accordingly adapted to form a terminal for the modulation of an incoming power from the battery 110.

While in operation, a user depresses the switch 102 either in the first depressed state 202′, or in the second depressed state 202″. When a small window opening is desired, the user may be required to maintain the switch 102 in the first depressed state 202′. The sensor disposed within the control unit 106 senses the position of the switch 102 and transfers position related information via signals to the CPU employed within the control unit 106. Subsequently, the CPU converts the received signals of the sensed position of the switch 102 into a compatible format, making the sensed position values readable by the algorithm installed within the control unit's memory. The algorithm upon receiving the processed signals, thereafter, processes the obtained signal via calculation methodologies through which the algorithm is developed, and eventually establishes a processed output. Here, the processed output obtained may be understood to include values derived from calculations based on a predefined and stored speed value with which the window 122 is intended to travel, and accordingly the algorithm establishes the corresponding voltage/current value, which is a modulated value in relation to the actual voltage/current value obtained from the battery 110. Once the modulated voltage/current value is estimated, the control unit 106 sends across the modulated voltage/current value to the regulator motor 112 through the connection cabling 108. Correspondingly, the regulator motor 112 receives the modulated voltage/current value and enables the regulator motor 112 to operate and drive the worm 118 at a slower speed, thereby regulating the window 122 according to the predefined and stored speed value, and not according to the full measure of the voltage/current of the battery 110. This enables a soft start feature for the regulator motor 112 and the window 122, thereby reducing minimum window activation distance and making it easier to control the window's stop point. It is understood that in such a configuration the soft start feature may be applicable till the time the user maintains the switch 102 in the first depressed state 202′.

Pulse Width Modulation (PWM) systems can be used by the control unit 106 to modulate and control an incoming voltage and/or current value. Accordingly, window regulation systems, like the system 100, utilizing Pulse Width Modulation techniques, may include sub-switch or sub-relays to confer implications of an incoming voltage and/or current by varying the electrical connection at a fast pace. The longer the sub-switch is on compared to the off periods, the higher the power supplied to the load will be, where the load is understood to be window regulation. Such sub-switch configurations and incorporations may be enabled through the control unit 106. To this end, the control unit 106 may sense the position of the switch 102 and may vary the sub-switch according to the physical position of the detent of the switch 102, along with the tracked time, which is configured to be monitored through the timer optionally. In summation, PWM enables control and modulation of either or both the voltage and/or current obtained through the battery 110. Techniques such as PWM and the like, configured to modulate a voltage and/or current value, are well known to the skilled in the art and thus will not be discussed further.

Alternatively, the switch 102 may include window regulation functionalities, associated with the twin depression states 202′ and 202″ of the switch 102, to be based upon certain predefined schedules. One such predefined schedule may be time based window regulation. According to such a schedule, every window closing and opening operation may include a soft start feature for a predefined initial period for which the switch 102 is depressed to a particular position. The timer employed within the control unit 106 may enable storage of the time for which the window needs to travel at a corresponding predefined speed or according to a speed profile, and may enable monitoring of the time for which the switch 102 is depressed. Another predefined schedule may be based on the distance of the window travel. This may be enabled through a predefined value of distance stored within the control unit 106, such that an activation of the switch 102 may enable the window 122 to travel at a predefined speed only up to the predefined distance value via the modulated power. The predefined distance may be sensed using a position sensor. Beyond the predefined distance or period, the window 122 may resume operations according to the original unmodulated power supplied by the battery 110. As an example, during the switch's first detent, the window 122 may travel at a speed of 5 mm/sec, up to a time of 5 seconds, or up to a distance of 25 mm, while in the second detent, the window 122 may travel at a speed of 10 mm/sec up to a time of 3 seconds or up to a distance of 30 mm. Optionally, the second depression state 202″ may include provisions to operate the window 122 ordinarily, as known in conventional applications, enabling the window 122 to travel all the way to the closed or to the open position without any power modulation as well.

Correspondingly, the switch 102, when having multiple detent positions, may include predefined schedules potentially for every position, enabling the window 122 to function according to different predefined schedules for every detent. Advantageously, multiple switch detents may enable the window's position to be controlled at multiple travel speeds up to different travel distances or up to different time values set for every detent.

In some embodiments, the switch 102 may incrementally modulate the battery power along with the act of depression or release of the switch 102, enabling the window to travel at a higher speed when depressed relatively more, while slowing down when depressed relatively less, or vice versa.

Moreover, in-vehicular provisions could be provided to a user to feed and vary the initial period or predefined distance for which the window 122 achieves a speed according to the modulated power supplied across the system 100, for every position of the switch 102. The speed of window operation may be varied as well. When required to have only a single predefined schedule for a window operation, the switch 102 may be configured to include only a single detent. On desired occasions, the user may even disable the switch 102 to include the above functionalities, enabling the switch 102 to be ordinarily operated between two modes, as known in conventional applications.

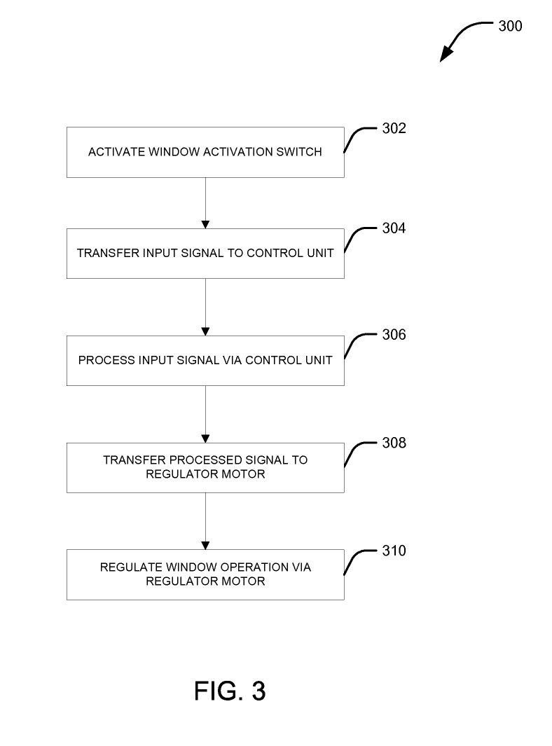

The system set out above is further explained in the flowchart shown in FIG. 3, which depicts an exemplary window regulation method 300. It is understood that the methodology presented here through the flowchart is identical to the methodology discussed in connection with FIG. 1.

Accordingly, at stage 302, upon an activation of the window activation switch 102, the control unit 106, forming one part of the switching unit 104, senses the position of the switch 102 through a position sensor employed within the control unit 106. If the switch 102 is sensed to have been depressed up to the first depressed state 202′, the sensor sends a corresponding input signal to the control unit 106 at stage 304. At stage 306, the control unit 106, through the CPU converts the incoming signal information into a compatible format, making it readable for the installed algorithm. As part of processing, the algorithm processes the signal and establishes a processed output determining an amount of voltage/current modulation required on the incoming value of voltage/current from the battery 110. More particularly, this occurs based upon a predefined amount of travel speed required for window regulation. The processed signal in then transferred to the regulator motor 112, enabling the regulator motor 112 to regulate the speed of the window 122 based on the modulated value of voltage/current, the transfer occurring at stage 308. Subsequently, at stage 310, the regulator motor 112 regulates the window operation, by operating the window according to the input passed on by a user of the system 100. A full depression of the switch 102, thereafter would cause the window to travel all the way through, either to the totally closed position or the totally open position.

An advantage of the present disclosure utilizing a soft start feature for controlling movements of the window 122 is to have a better user control of window positions for small distances and/or short time activations. Soft start feature in the system 100 also improves the system's durability by reducing stress in the window lift motor or the regulator motor, such as the regulator motor 112, during hard window starts.

Soft start features, such as the one disclosed, may be implemented to take advantage of potential durability improvements and/or to avoid vibration issues as well. For example, sound impact and glass vibration on start of the regulator motor 112 during the window's pullout of header seals may be minimized. Further, reducing the regulator motor's voltage/current reception could also be used to slow the window 122 down near a hard stop or at midway travel. Slowing the window 122 down prior to stalling on a hard up/down stop or into window boundary seals can also reduce stress on the system 100 and prevent unwanted noise, vibration, and harshness associated with the hard physical contact with a window seal. Slowing the window down in sensitive locations, anywhere along the travel, may allow more robust implementation of “anti-pinch” algorithms, particularly in cases where compliance with legal regulations is required.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

1. A window regulation system in a vehicle, the system comprising:
a window, a vehicular window frame supporting the window;
a regulator motor;
a drive arrangement connected to the vehicular window frame, the regulator motor, and to the window, to raise and lower the window in relation to the vehicular window frame;
a window activation switch connected to a vehicular power source and to the regulator motor for a window operation; and
a control unit connected to the window activation switch, the control unit including:
a first mode of operation which causes the regulator motor and the drive arrangement to move the window at a first speed, and a second mode of operation enabling the window to travel further at a different second speed, the second speed being faster than the first speed, wherein, the control unit is further configured to employ the first mode of operation for a predetermined time, and then to employ the second mode of operation.

2. The system of claim 1, wherein
the activation switch has a predefined position, and
the control unit maintain continues employment of the first mode of operation when the activation switch is in the predefined position.

3. The system of claim 2, wherein the window activation switch predefined position is a partially depressed state.

4. The system of claim 1, wherein the drive arrangement includes a worm drive arrangement.

5. The system of claim 1, wherein both the first mode of operation and the second mode of operation is enabled through at least one of the following:
control of an incoming voltage value; and
control of an incoming current value.

6. The system of claim 5, wherein the control of both the incoming voltage value and the incoming current value is enabled through pulse width modulation.

7. A method to regulate a window in a vehicle, the method comprising:
activating a window activation switch, the window activation switch being connected to a vehicular power source and to a regulator motor for window operation, the activation forming an input signal;
transferring the input signal obtained through the window activation switch to a control unit;
processing the input signal via the control unit to form an output, the output being a processed signal;
transferring the processed signal to the regulator motor; and
regulating window operation via the processed signal through a drive arrangement, the drive arrangement configured to operate the window in relation to a vehicular window frame, wherein the control unit, providing the processed signal, comprises:
a first mode of operation which causes the regulator motor and the drive arrangement to move the window at a first speed, and a second mode of operation enabling the window to travel further at a different second speed, the second speed being faster than the first speed, the control unit being configured to employ the first mode of operation for a predetermined time, and then to employ the second mode of operation.

8. The method of claim 7, wherein
the activation switch has a predefined position, and
the control unit maintain continues employment of the first mode of operation when the activation switch is in the predefined position.

9. The method of claim 2, wherein the window activation switch predefined position is a partially depressed state.

10. The method of claim 7, wherein both the first mode of operation and the second mode of operation is enabled through at least one of the following:
control of an incoming voltage value; and
control of an incoming current value.

11. The method of claim 10, wherein the control of both the incoming voltage value and the incoming current value is enabled through pulse width modulation.

12. The method of claim 7, wherein the drive arrangement is connected to the vehicular window frame.

13. The method of claim 7, wherein the drive arrangement includes a worm drive arrangement.

14.-20. (canceled)
